(19) United States
(12) Patent Application Publication
(10) Pub. No.: US 2009/0170023 A1
(43) Pub. Date: Jul. 2, 2009

(54) PROCESS FOR PRODUCING ELECTROPHOTOGRAPHIC PHOTOSENSITIVE MEMBER

(75) Inventors: Akira Shimada, Suntoh-gun (JP); Hiroki Uematsu, Suntoh-gun (JP); Masataka Kawahara, Mishima-shi (JP); Kyoichi Teramoto, Abiko-shi (JP); Akio Maruyama, Tokyo (JP); Toshihiro Kikuchi, Yokohama-shi (JP); Akio Koganei, Ichikawa-shi (JP); Takayuki Sumida, Kawasaki-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/389,180

(22) Filed: Feb. 19, 2009

Related U.S. Application Data
(63) Continuation of application No. 11/770,006, filed on Jun. 28, 2007.
Application No. 11/770,006 is a continuation of application No. PCT/JP2007/051850, filed on Jan. 30, 2007.

(30) Foreign Application Priority Data
Jan. 31, 2006 (JP) 2006-022896
Jan. 31, 2006 (JP) 2006-022898
Jan. 31, 2006 (JP) 2006-022899
Jan. 31, 2006 (JP) 2006-022900
Jan. 26, 2007 (JP) 2007--016220

(51) Int. Cl. G03G 5/02

(52) U.S. Cl. 430/130

(57) ABSTRACT

A process for producing an electrophotographic photosensitive member. The electrophotographic photosensitive member includes a conductive support and a surface layer provided thereon containing at least a resin. The process has the step of forming a plurality of depressed portions on the surface layer by irradiation with laser light having a wavelength of 400 nm or less and having an output characteristic of a pulse width of 100 ns or less.

This application is a continuation application of U.S. patent application Ser. No. 11/770,006, filed Jun. 28, 2007, which is a continuation of International Application No. PCT/JP2007/051850, filed Jan. 30, 2007, which claims the benefit of Japanese Patent Application No. 2006-022900, filed Jan. 31, 2006, Japanese Patent Application No. 2006-022898, filed Jan. 31, 2006, Japanese Patent Application No. 2006-022896, filed Jan. 31, 2006, Japanese Patent Application No. 2006-022899, filed Jan. 31, 2006 and Japanese Patent Application No. 2007-016220, filed Jan. 26, 2007. All of the aforementioned prior applications are incorporated herein by reference.

### BACKGROUND OF THE INVENTION

1. Field of the Invention

This invention relates to a process for producing an electrophotographic photosensitive member, and more particularly to a process for producing a surface-roughened electrophotographic photosensitive member to obtain an electrophotographic photosensitive member having good cleaning performance and electrophotographic properties.

2. Background of the Related ART

Electrophotographic photosensitive members employ in their image formation process a repeating course of charging, exposure, development, transfer, cleaning and charge elimination. In particular, the cleaning step which removes the toner remaining on the electrophotographic photosensitive member after the transfer step is an important step in order to obtain sharp images. A method for this cleaning may firstly include a method in which a rubbery plate member called a cleaning blade is brought into contact with the electrophotographic photosensitive member surface to eliminate any gap between the cleaning blade and the electrophotographic photosensitive member so that the toner can be prevented from escaping, to thereby scrape the residual toner off. It may secondly include a method in which a fur brush roller is so rotated as to come into contact with the electrophotographic photosensitive member surface to wipe or tap the residual toner off. Of these cleaning methods, rubber blade cleaning is advantageous in view of cost and ease for design, and the cleaning using the cleaning blade is prevalent at present. Especially where full-color development is performed, a plurality of colors such as magenta, cyan, yellow and black are superimposed to bring out desired colors. Accordingly, toners are used in much larger quantities than the case of monochrome development, and hence the cleaning method in which the rubber blade is brought into pressure contact with the electrophotographic photosensitive member surface is best.

However, a cleaning blade showing a good cleaning performance has such large frictional force as to raise a problem in that the cleaning blade tends to turn up. This turn-up of the cleaning blade is a phenomenon in which the cleaning blade warps in the surface movement direction of the electrophotographic photosensitive member.

In recent years, methods for producing hard electrophotographic photosensitive member surfaces have been put forward in order to ensure the long life of electrophotographic photosensitive members. For example, a technique has been established in which a curable resin, not a plastic resin, is used in a surface layer. The above phenomenon of cleaning blade turn-up more tends to come about when electrophotographic photosensitive members are made to have hard surfaces, i.e., not to easily be abraded.

Where a toner is made to have a uniform particle diameter in order to improve image quality, and fine toner particles have been removed, lubricity is reduced which is brought about by toner entering the gap between the cleaning blade and the electrophotographic photosensitive member. Hence, the cleaning blade is more liable to turn up.

In particular, where full-color development is performed, development is performed at plural times for magenta, cyan, yellow and black, and hence a load applied to the cleaning blade increases so that blade turn-up and chipping of the blade edge are liable to occur.

In addition, in the developing system, the cleaning blade comes into pressure contact with external additives of the toner and with foreign matter such as paper dust of transfer sheets, and these may be buried in the electrophotographic photosensitive member surface portion to cause toner melt adhesion starting from these. This phenomenon may remarkably occur in a high-temperature and high-humidity environment.

As a method for solving these problems to which the cleaning step pertains, a method is proposed in which the electrophotographic photosensitive member surface is appropriately roughened to lessen the contact area between the electrophotographic photosensitive member surface and the cleaning blade.

Charge products generated through a charging means in an electrophotographic apparatus may be deposited on the electrophotographic photosensitive member, or the surface of the electrophotographic photosensitive member may deteriorate because of electrification from the charging means, to cause smeared images. While the smeared images may occur in both cases where the electrophotographic apparatus is, and is not, provided with the above electrophotographic photosensitive member cleaning means, they tend to remarkably occur especially when the electrophotographic apparatus is not provided with the above electrophotographic photosensitive member cleaning means. Further, the smeared images may more remarkably occur in a high-temperature and high-humidity environment. The above roughening of the electrophotographic photosensitive member surface is known to be an effective measure against the smeared images as well.

As the roughening of the electrophotographic photosensitive member surface, a method is disclosed in which drying conditions at the time of forming the photosensitive layer are controlled to roughen the photosensitive layer surface (see Patent Document 1). This method basically does not require any special investment for installation because the surface is roughened in a usual photosensitive layer formation step. However, this method requires precise control of drying temperature, drying time, coating fluid volatile components at the time of coating, coating environmental temperature, flow of air at the time of coating, etc. Otherwise, it is difficult to achieve reproducibility of the rough surface state of the photosensitive member surface.

A method is also known in which powder particles are previously added to a surface layer to roughen the surface (see Patent Document 2). However, in general, where a powder is added to the electrophotographic photosensitive member, only a few powders are available which are suited for electrophotographic photosensitive members in respect of the materials and dispersibility of powders. Further, such powder may adversely affect properties of electrophotographic photosensitive members, in particular, definition of images, depending on its addition amount. Thus, this can be said to be a method having many limitations.

As processing for mechanical surface roughening, a method is proposed in which the photosensitive member surface is sanded by using a wire brush made of a metal (see Patent Document 3). This method has a difficulty that, when the brush is continuously used, it is difficult to achieve reproducibility of roughening because brush bristle ends may deteriorate or sanding dust may adhere to the bristle ends.

As another method for mechanical surface roughening, a method is disclosed in which the surface is sanded with a filmy sanding material (see Patent Document 4). In this method, a fresh surface of the filmy sanding material can always be used in the sanding in virtue of a film winding unit, thus enabling reproducibility of the surface-roughening to be achieved. However, the filmy sanding material is disadvantageous in that it involves a high cost and a long sanding time. Thus, this method has a problem on productivity.

Patent Document 4 discloses that the surface of an electrophotographic photosensitive member is roughened by sandblasting. The sandblasting enables relatively short time processing. However, it brings about dust, and hence it is indispensable to prevent or mitigate any influences on the step of photosensitive layer formation which is a step immediately anterior to the sandblasting. Specifically, it is necessary to take measures that, e.g., a processing chamber for each processing must separately be provided and the air must be prevented from coming and going between the chambers.

This leads to a rise in cost.

Patent Document 1: Japanese Patent Application Laid-open No. S53-92133

Patent Document 2: Japanese Patent Application Laid-open No. S52-26226

Patent Document 3: Japanese Patent Application Laid-open No. S57-94772

Patent Document 4: Japanese Patent Application Laid-open No. H02-150850

### SUMMARY OF THE INVENTION

An object of the present invention is to provide a process for producing an electrophotographic photosensitive member which can effectively keep toner melt adhesion and faulty images such as smeared images from occurring even where cleaning blade contact pressure and environments for forming electrophotographic images are disadvantageous to keeping these from occurring.

### Means for Solving Problems

To achieve the above object, the present invention provides a process for producing an electrophotographic photosensitive member provided with a conductive support and a surface layer provided thereon, the surface layer comprising at least a resin, and having a plurality of depressed portions on the surface thereof, the process comprising the step of forming the depressed portions by irradiation with laser light having a wavelength of 400 nm or less and having an output characteristic of a pulse width of 100 ns or less.

The present invention also provides a process for producing an electrophotographic photosensitive member provided with a conductive support and a photosensitive layer comprising a charge generating material and a charge transporting material, provided on the conductive support, and the electrophotographic photosensitive member having a surface layer whose surface has been roughened with a plurality of depressed portions formed thereon, the surface layer comprising a resin, the process comprising the step of forming the depressed portions by irradiating with laser light having a pulse width of 100 ns or less, emitted from a laser having an oscillation wavelength in a wavelength region of 400 nm or less, and subjecting the surface layer to abrasion processing.

### EFFECT OF THE INVENTION

According to the present invention, scraping, chattering or chipping of a cleaning blade, toner escape and faulty cleaning do not occur even under wide-range conditions of from high contact pressure to low contact pressure of the cleaning blade, and setting of cleaning can be made with wide latitude. An electrophotographic photosensitive member can also be provided which does not cause toner melt adhesion and faulty images such as smeared images which are liable to occur when used in a high-temperature and high-humidity environment.

In particular, the above problems, which are raised especially when an electrophotographic photosensitive member having a cured layer as the outermost surface layer is used aiming at providing it with higher durability, can continue to be effectively remedied from the initial stage until after printing a large number of sheets.

### BRIEF DESCRIPTION OF THE DRAWINGS

FIG. 1 is a view showing an example of an arrangement pattern (partial enlarged view) of a mask.

FIG. 2 is a schematic view showing the construction of a laser surface processing unit.

FIG. 3 is a view showing an arrangement pattern of depressed portions (partial enlarged view) of the photosensitive member outermost surface obtained in the present invention.

FIG. 4 is a schematic view showing an example of the construction of an electrophotographic apparatus provided with a process cartridge having the electrophotographic photosensitive member according to the present invention.

FIG. 5 is a view showing an arrangement pattern (partial enlarged view) of a mask used in Example 1.

FIG. 6 is a view showing an arrangement pattern of depressed portions (partial enlarged view) of the photosensitive member outermost surface obtained in Example 1.

FIG. 7 is a view showing an arrangement pattern (partial enlarged view) of a mask used in Example 2.

FIG. 8 is a view showing an arrangement pattern of depressed portions (partial enlarged view) of the photosensitive member outermost surface obtained in Example 2.

FIG. 9 is a view showing an arrangement pattern (partial enlarged view) of a mask used in Example 4.

FIG. 10 is a view showing an arrangement pattern of depressed portions (partial enlarged view) of the photosensitive member outermost surface obtained in Example 4.

FIG. 11 is a view showing an arrangement pattern (partial enlarged view) of a mask used in Comparative Example 3.

### DESCRIPTION OF THE EMBODIMENTS

The present invention has the step of forming a plurality of depressed portions on a surface layer of an electrophotographic photosensitive member by irradiating the surface layer with laser light having a wavelength of 400 nm or less and having an output characteristic of a pulse width of 100 ns or less.

The electrophotographic photosensitive member has as its layer constitution any one of the following.

(1) A function-separated type multi-layer structure having a charge generation layer and a charge transport layer formed on the surface side of the charge generation layer.

(2) A constitution in which a charge generating material and a charge transporting material are dispersed in the same layer.

(3) A constitution in which a protective layer is formed on the photosensitive layer in the above (1) or (2) for the purpose of elongating the lifetime.

The surface layer to be surface-roughened in the present invention refers to the charge transport layer in the above (1), the single-layer photosensitive layer in the above (2), and the protective layer in the above (3).

A laser emitting laser light with a short pulse width, such as excimer lasers using Arf, KrF, XeF or XeCl as a laser medium, has a high peak output of laser light. Hence, the so-called abrasion processing is possible in which eruption instantaneously takes place before an object to be irradiated is affected by heat. The abrasion processing by laser light refers to processing in which an object to be irradiated is sublimated by irradiation with laser light without undergoing a liquid-phase state.

The laser light may preferably have a pulse width of 100 ns or less, and more preferably 50 ns or less. With laser light having a pulse width of more than 100 ns, the peak output is insufficient, and hence heat generation takes place at the portion irradiated therewith, so that fusion or carbonization is brought about. In this case, depressed portions with rises (berms) at their rims are often formed on the surface of the object to be irradiated. Such depressed portions can not exhibit the effect the present invention aims at. Also in continuous-oscillation type CO₂ lasers and YAG lasers used widely for laser processing, as in laser light having a pulse width of more than 100 ns, irradiated portions are affected greatly by heat. Hence, depressed portions with berms at their rims are inevitably formed as stated above. Thus, it is undesirable to use these lasers in the surface processing for solving the problems presented by the present invention.

In general, laser light used in abrasion processing has a wavelength of 1,000 nm or less, and further 800 nm or less. Laser light having a long wavelength is low in absorptivity in the resin to be irradiated so that abrasion processing is not effected at irradiated portions, where heat generation takes place.

Where the electrophotographic photosensitive member is irradiated with light having a short wavelength of 400 nm or less, problems such as rise or drop in light-area potential, fogging and photomemory are known to come about in the subsequent repeated use with charging and exposure. The cause thereof is considered to be due to the fact that the charge transporting material or charge generating material forms components which trap charge carriers by the action of such short-wavelength light (see Japanese Patent Application Laid-open No. S58-160957). For solving the problems presented by the present invention, it has been considered undesirable that in the surface processing of the electrophotographic photosensitive member, it is irradiated with laser light emitted by a laser having an oscillation wavelength in such a wavelength region. However, as a result of studies made by the present inventors, it has come to light that irradiation of the electrophotographic photosensitive member with laser light having a wavelength of 400 nm or less and having an output characteristic of a pulse width of 100 ns or less does not have such a bad influence on the properties of photosensitive members as stated above. More specifically, depressed portions which can reduce faulty images resulting from blade turn-up and toner melt adhesion have been able to be very efficiently formed while preventing the electrophotographic properties of an electrophotographic photosensitive member from being affected.

The laser having a wavelength of 400 nm or less and having an output characteristic of a pulse width of 100 ns or less may specifically include an excimer laser using Arf, KrF, XeF or XeCl as a laser medium.

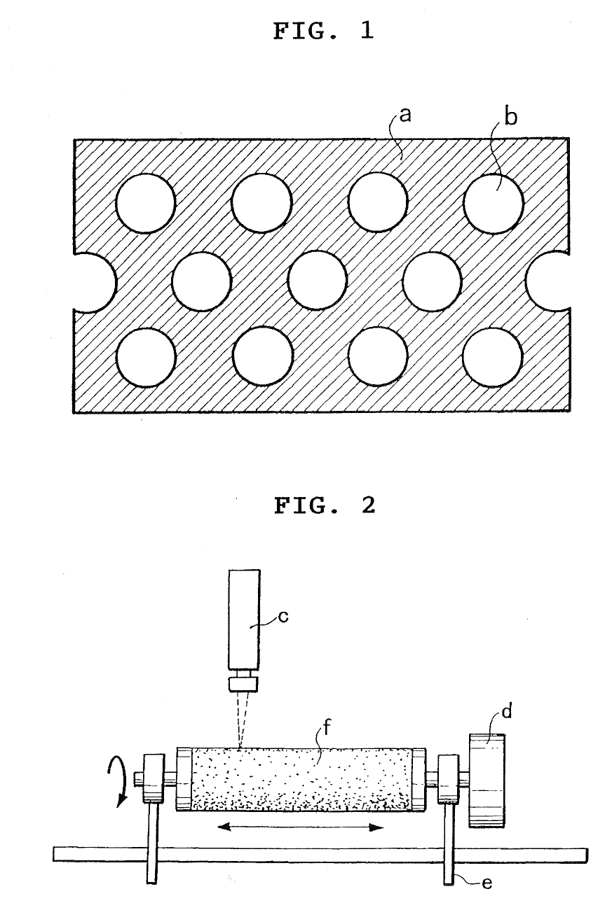

In the present invention, fine depressed portions are formed in a large number on the electrophotographic photosensitive member surface by using such laser light having a suitable pulse width, thereby roughening the electrophotographic photosensitive member surface. In a specific method for forming the depressed portions, a mask is used in which transparent areas to the laser light “a” and opaque areas to the laser light “b” are appropriately arranged as shown in FIG. 1. Only the laser light transmitted through the mask is converged with a lens, and the object to be irradiated is selectively irradiated with the laser light. This enables the depressed portions having the desired shape and arrangement to be formed. The surface processing can be carried out instantly and simultaneously to form a large number of depressed portions in a certain area without regard to the shape and area of the depressed portions. Hence, the processing step can be carried out in a short time. The laser light irradiation using such a mask may be performed for each unit area of from several mm² or more and several cm² or less for each irradiation, to form an arrangement pattern of the depressed portions. The region irradiated selectively with the laser light on the surface of the surface layer is shifted to process the surface layer at different positions of the surface. This can repeatedly be carried out to form the depressed portions over all the predetermined areas of the surface of the surface layer.

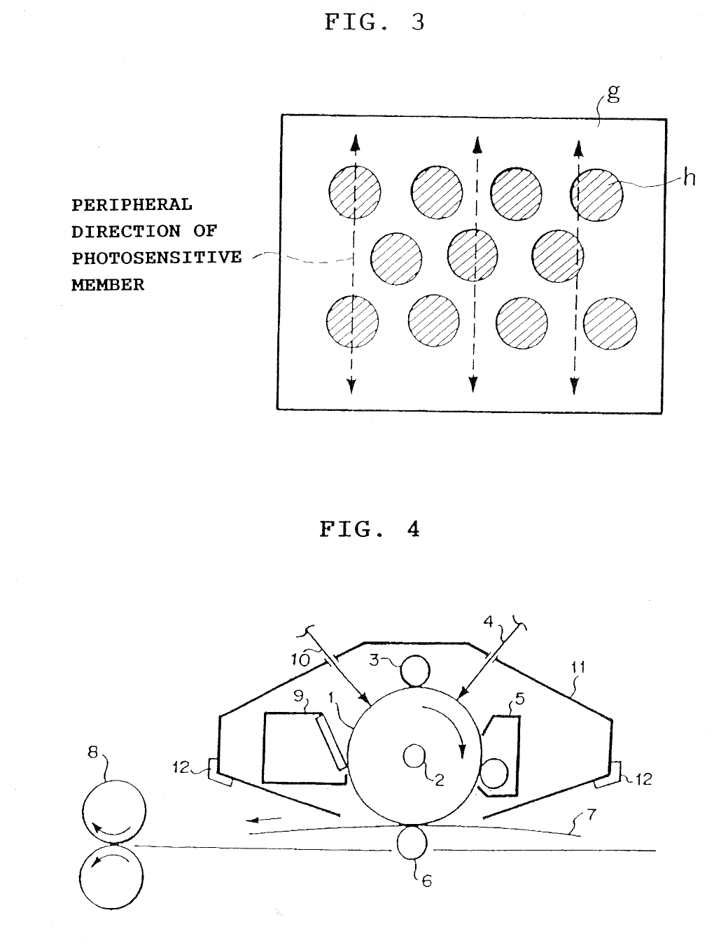

As shown in FIG. 2, a laser surface-processing unit may be provided with a mechanism e by which the position irradiated with laser light from a laser light irradiator c is shifted in the axial direction of an object to be processed f and a mechanism d by which the object to be processed is rotated, thereby enabling the depressed portions to be formed in good efficiency over the whole surface area of the object to be processed. The depressed portions may preferably have a depth of from 0.1 μm to 2.0 μm, and more preferably from 0.3 μm to 1.2 μm. The depth of depressed portions refers to an average value of depths of the depressed portions at their deepest bottoms as measured with a laser microscope (VK-9500, manufactured by Keyence Corporation). According to the present invention, it is possible to materialize surface processing which is high in controllability of the size, shape and arrangement of the depressed portions, and is higher in precision and degree of freedom in comparison with such conventional surface-roughening methods as described previously.

In the present invention, the surface processing is repeatedly carried out using a mask pattern having the same unit area so that depressed portions can be formed with high surface-roughening uniformity over the whole electrophotographic photosensitive member surface. As a result, a mechanical load to be applied to the cleaning blade when used in an electrophotographic apparatus can be uniform. In addition, as shown in FIG. 3, the mask pattern may be formed so that both depressed portions and non-depressed portions are present on any lines in the peripheral direction of the electrophotographic photosensitive member, whereby a mechanical load to be applied to the cleaning blade is further prevented from being localized.

In addition, in the production process according to the present invention, powder dust is not generated at the production site. Thus, it is unnecessary to provide a shield between the step of surface-roughening and the step of forming the photosensitive layer, in setting up a production line.

Next, it will be described how to produce the electrophotographic photosensitive member in the present invention.

As mentioned previously, the photosensitive layer of the electrophotographic photosensitive member has the function-separated type multi-layer structure having at least a charge generation layer and a charge transport layer, or the single-layer structure made to have both the functions in one layer. Further, in some cases, a protective layer may also be provided on the outermost surface for the purpose of prolonging the lifetime of the electrophotographic photosensitive member have.

The charge generation layer may be formed as a vacuum-deposition layer on a conductive support by means of a vacuum deposition system, or may be formed by applying a fluid prepared by dispersing a charge generating material in a binder resin using a suitable solvent, then passing through the step of drying and curing, such as heating, the wet-coating formed. The binder resin in the charge generation layer may preferably have a proportion of 90% by mass or less, and particularly preferably 50% by mass or less, based on the total mass of the charge generation layer. The charge generation layer may preferably have a layer thickness of from 0.001 μm to 6 μm, and particularly preferably from 0.01 μm to 1 μm.

The charge generating material used in the photosensitive layer may include the following: inorganic charge generating materials such as selenium, selenium-tellurium, and amorphous silicon; pyrylium dyes and thiapyrylium dyes; phthalocyanine pigments having various central metals and various crystal types (such as α, β, γ, ε and X forms); anthanthrone pigments; polycyclic quinone pigments such as dibenzpyrenequinone pigments and pyranthrone pigments; cationic dyes such as azulenium dyes, thiacyanine dyes and quinocyanine dyes; squalium salt dyes; indigo pigments; quinacridone pigments; and azo pigments.

These may be used alone or in combination.

The binder resin may include the following: insulating resins such as polyvinyl butyral, polyarylate (such as a polycondensation product of bisphenol A and phthalic acid), polycarbonate, polyester, polyvinyl acetate, acrylic resins, polyacrylamide, polyamide, cellulose resins, urethane resins, epoxy resins, and polyvinyl alcohol; and organic photoconductive resins such as poly-N-vinyl carbazol and polyvinyl pyrene.

The charge transport layer may be formed by applying a fluid prepared by dispersing a charge transporting material in a binder resin using a suitable solvent, then passing through the step of drying and curing, such as heating. The binder resin and the charge transporting material may be mixed in such a proportion that the charge transporting material is in an amount of from 20% by mass to 80% by mass, and particularly preferably from 30% by mass to 70% by mass, based on the total mass of the charge transport layer. The charge transport layer may preferably have a layer thickness of from 5 μm to 50 μm.

The charge transporting material may include the following: Polycyclic aromatic compounds having a structure such as biphenylene, anthracene, pyrene, or phenanthrene in their backbone chains or side chains; nitrogen-containing cyclic compounds such as indole, carbazole, oxadiazole and pyrazoline; and hydrazone compounds, and styryl compounds. These may be used alone or in combination.

The binder resin may include the following: polycarbonate, polyester, polyurethane, polysulfone, polyarylate, polyvinyl butyral, polyamide, phenoxy resins, acrylic resins, acrylonitrile resins, methacrylic resins, phenolic resins, epoxy resins, and alkyd resins.

These charge transporting material and binder resin may be in a proportion between about 1:5 and about 5:1, which may be determined in accordance with electrophotographic properties, printing durability and other requirements. The solvent may be selected from those in which the charge transporting material and the binder resin are soluble. In some cases, additives adapted to various requirements according to electrophotographic processes, other than electrophotographic properties, such as an antioxidant and a lubricant may optionally be added to the coating fluid.

In the case where the photosensitive layer is used as a single layer, the charge generating material, the charge transporting material and the binder resin are incorporated in the same layer. Specific examples of the charge generating material, charge transporting material and binder resin are the same as those in the case of the multi-layer electrophotographic photosensitive member. The single-layer photosensitive layer may preferably have a thickness of from 8 μm to 40 μm, and more preferably from 12 μm to 30 μm. Photoconductive materials such as the charge generating material and the charge transporting material may preferably be contained in an amount of from 20% by mass to 80% by mass, and more preferably from 30% by mass to 70% by mass.

The present invention may also be applied to an electrophotographic photosensitive member constituted to further have a protective layer on the photosensitive layer. A binder resin and a charge transporting material which are used in the protective layer may include the same ones as the materials the charge transport layer described above contains.

The protective layer may further be incorporated with a conductive material such as a metal or an oxide, nitride, salt or alloy thereof, or carbon. The conductive material is in the form of fine particles, and may be used in a state in which it stands dispersed in the protective layer. The conductive material may preferably have a particle diameter of from 0.001 μm to 5 μm, and more preferably from 0.01 μm to 1 μm. The conductive material may preferably be added to the protective layer in an amount of from 1% by mass to 70% by mass, and more preferably from 5% by mass to 50% by mass. The protective layer may further be incorporated with a titanium coupling agent or a silane coupling agent, and a dispersant such as various types of surface-active agents.

A cured-resin layer (hereinafter referred to also as a “cured layer”) may also be used as the protective layer. The cured layer may be formed by applying a protective layer forming coating fluid incorporated with a monomer or oligomer having a polymerizable functional group, followed by drying.

Thereafter, the film formed is heated and irradiated with radiations to effect polymerization, and is three-dimensionally cross-linked and cured, thus a tough cured layer is formed which is insoluble and infusible in solvents. The cured layer at the outermost surface may have a charge transporting function. For example, it is preferable that a film is formed by applying a coating fluid containing a charge transporting compound having a polymerizable functional group in the same molecule, followed by curing to obtain a photosensitive layer the surface of which is cured. In order for the cured layer on the surface to have higher strength, it is preferable to employ as the cured layer forming material a charge transporting compound in which two or more polymerizable functional groups are present in the same molecule. The protective layer may preferably have a layer thickness of from 0.05 μm or more and 10 μm or less, and particularly preferably from 0.5 μm or more and 8 μm or less.

In the present invention, the protective layer may contain a lubricant. The lubricant may include the following materials: N-(n-propyl)-N-(β-acryloxyethyl)-perfluorooctylsulfonic acid amide, N-(β-propyl)-N-(β-methacryloxyethyl)-perfluorooctylsulfonic acid amide, perfluorooctanesulfonic acid, perfluorocaprylic acid, N-n-propyl-n-perfluorooctanesulfonic acid amide-ethanol, 3-(2-perfluorohexyl)ethoxy-1,2-dihydroxypropane, N-n-propyl-N-2,3-dihydroxypropyl perfluorooctylsulfonamide, and fluorine atom-containing resin particles.

In the present invention, the protective layer may be incorporated with a resistance modifier. The resistance modifier may include the following: SnO₂, ITO, carbon black, and silver particles. Also, it is possible to use the above having been subjected to surface treatment such as hydrophobic treatment. The surface layer to which the resistance modifier has been added may preferably have a resistivity of from 10⁹ Ω·cm to 10¹⁴ Ω·cm.

The support used in the present invention may be made of a material which may include the following: Metals such as aluminum, aluminum alloys, copper, zinc, stainless steel, vanadium, molybdenum, chromium, titanium, nickel, indium, gold and platinum; plastics film-formed thereon by vacuum deposition of metals or alloys; plastics, metals or alloys coated with conductive fine particles such as carbon black or silver particles together with a suitable binder resin; and plastics or paper impregnated with conductive fine particles.

The support is preferably made to have a shape most suitable for an electrophotographic apparatus to be used, including the shape of a drum, the shape of a belt and the shape of a sheet.

In the present invention, a subbing layer may be provided between the support and the photosensitive layer. The subbing layer has a function of covering surface defects of the support and a function as a barrier. The subbing layer may be formed by coating a fluid prepared by dispersing a conductive filler in a binder resin using a suitable solvent, then passing through the step of drying and curing, such as heating. The conductive filler may include the following: Tin oxide, indium oxide, titanium dioxide, and carbon. The binder resin may include the following: Phenol, melamine, polyvinyl alcohol, polyethylene oxide, ethyl cellulose, methyl cellulose, casein, polyamide, glue, and gelatin.

In the present invention, an intermediate layer may be provided between the support and the photosensitive layer or between the subbing layer and the photosensitive layer. The intermediate layer has functions of controlling injection of carriers from the support and improving adhesion between the support and the photosensitive layer. The intermediate layer may be incorporated with the above metal, alloy, or oxide or salt thereof, and a surface-active agent.

The resin used in the intermediate layer may include the following: Polyester, polyurethane, polyarylate, polyethylene, polystyrene, polybutadiene, polycarbonate, polyamide, polypropylene, polyimide, phenolic resins, acrylic resins, silicone resins, epoxy resins, urea resins, allyl resins, alkyd resins, polyamide-imide, polysulfone, polyallyl ethers, polyacetal, and butyral resins.

The intermediate layer may have a layer thickness of 0.05 μm or more and 7 μm or less, and particularly preferably 0.1 μm or more and 2 μm or less.

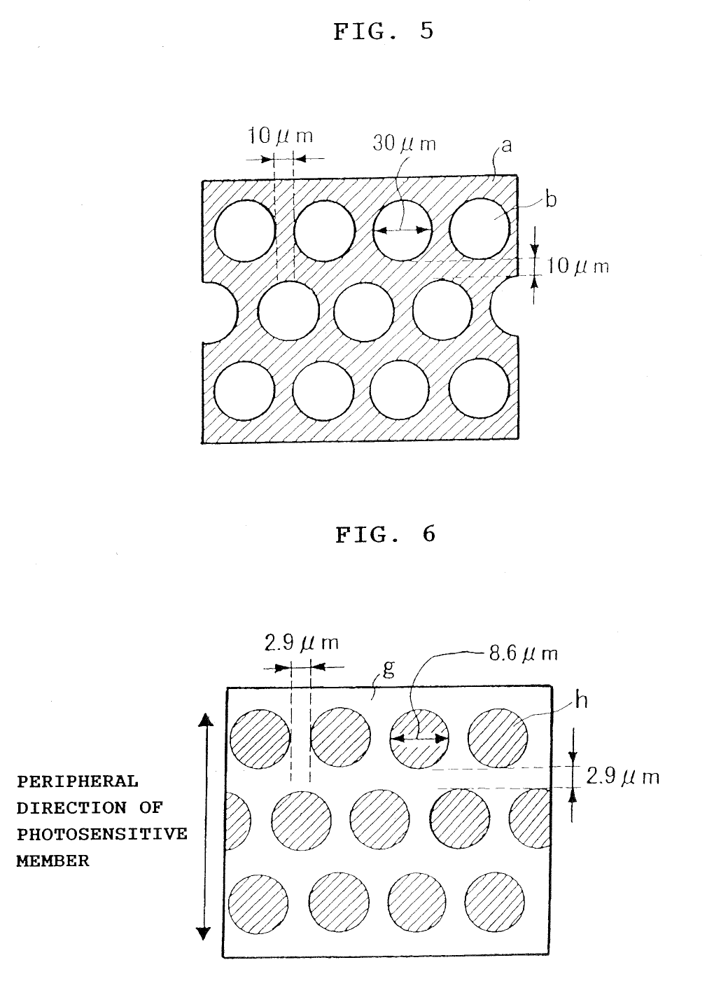

FIG. 4 schematically illustrates the construction of an electrophotographic apparatus provided with a process cartridge having the electrophotographic photosensitive member in the present invention.

In FIG. 4, reference character 1 denotes a drum-shaped electrophotographic photosensitive member in the present invention, which is rotatively driven around an axis 2 in the direction of an arrow at a predetermined peripheral speed (process speed). The electrophotographic photosensitive member 1 is, in the course of its rotation, uniformly charged on its peripheral surface to a given positive or negative potential through a primary charging means 3. Then, the electrophotographic photosensitive member thus charged is exposed to exposure light 4 the intensity of which has been modified corresponding to time-sequential electric digital image signals of the intended image information outputted from an exposure means (not shown) for slit exposure or laser beam scanning exposure according to light reflected from an original. In this way, electrostatic latent images corresponding to the intended image information are successively formed on the peripheral surface of the electrophotographic photosensitive member 1.

The electrostatic latent images thus formed are then rendered visible as transferable particle images (toner images) by regular development or reverse development with charged particles (a toner) held in a developing means 5. The toner images thus formed are successively transferred through a transfer means 6 to a transfer material 7 fed from a paper feed section (not shown) to the part between the electrophotographic photosensitive member 1 and the transfer means 6 in synchronization with the rotation of the electrophotographic photosensitive member 1. In this case, a bias voltage having a polarity reverse to charges possessed by the toner is applied to the transfer means from a bias power source (not shown).

The transfer material 7 (in the case of a final transfer material such as paper or film) to which the toner images have been transferred is separated from the surface of the electrophotographic photosensitive member, is transported to an image fixing means 8, where the images are fixed, and is discharged out of the apparatus as an image-formed material (a print or a copy). Where the transfer material 7 is a primary transfer material (such as an intermediate transfer material), the toner images are subjected to fixing processing after passing through plural transfer steps, and then discharged out of the apparatus.

The surface of the electrophotographic photosensitive member 1 from which images have been transferred is subjected to removal of transfer residual toner through a cleaning means 9, and thus cleaned. In recent years, cleanerless systems have been investigated in which the transfer residual toner is collected directly in a developing assembly. The electrophotographic photosensitive member thus cleaned is further subjected to charge elimination by pre-exposure light 10 emitted from a pre-exposure means (not shown), and then repeatedly used for image formation. Where the primary charging means 3 is a contact charging means using a charging roller, the pre-exposure is not necessarily required.

In the present invention, a plurality of components selected from the constituents such as the above electrophotographic photosensitive member 1, primary charging means 3, developing means 5 and cleaning means 9 may be held in a housing so as to be integrally combined as a process cartridge. This process cartridge is so set up as to be detachably mountable to the main body of an electrophotographic apparatus such as a copying machine or a laser beam printer.

For example, at least one of the primary charging means 3, the developing means 5 and the cleaning means 9 may integrally be supported together with the electrophotographic photosensitive member 1 to form a process cartridge 11. The process cartridge is so set up as to be detachably mountable to the main body of the apparatus through a guide means 12 such as rails installed in the main body of the apparatus.

In the case where the electrophotographic apparatus is a copying machine or a printer, the exposure light 4 is as follows: light reflected from, or transmitted through, an original; or light irradiated by scanning with a laser beam, driving of an LED array or driving of a liquid crystal shutter array according to signals into which an original read by a sensor is converted.

The electrophotographic photosensitive member in the present invention can be applied not only to electrophotographic copying machines, but also to electrophotographic apparatus in general, such as laser beam printers, LED printers, fax machines and liquid-crystal shutter printers. Further, the electrophotographic photosensitive member in the present invention is widely applicable to display, near-print, plate making, facsimile and the like equipment to which electrophotographic techniques have been applied.

### EXAMPLES

The present invention is described below in detail by way of specific working examples.

### Example 1

First, an aluminum cylinder of 370 mm in length, 84 mm in outer diameter and 3 mm in thickness was produced by cutting. This cylinder was washed with ultrasonic waves in pure water containing a detergent (trade name: CHEMICALL; available from Tokiwa Chemical Industry Co., Ltd.). Subsequently, after the step of washing away the detergent, the cylinder was further washed with ultrasonic waves in pure water to carry out degreasing treatment.

Next, a liquid mixture composed of the following materials was subjected to dispersion for about 20 hours by means of a ball mill to prepare dispersion.

| | (by mass) |
|---|---|
| Powder composed of barium sulfate particles coated | 10 parts |
| with tin oxide | |
| Titanium oxide powder | 2 parts |
| Resol type phenolic resin | 6 parts |
| (trade name: PHENOLITE J-325; available from | |
| Dainippon Ink & Chemicals, Incorporated; solid | |
| content: 70%) | |
| 2-Methoxy-1-propanol | 12 parts |
| Methanol | 3 parts |

The above dispersion was applied on the above degreased aluminum cylinder by dip coating, followed by heat drying and curing for 48 minutes in a hot-air dryer controlled at a temperature of 150° C., to form a conductive layer with a layer thickness of 15 μm.

Next, a solution was prepared by dissolving the following two types of nylon resins in a mixed solvent composed of 500 parts by mass of methanol and 250 parts by mass of n-butanol.

| | (by mass) |
|---|---|
| Copolymer nylon resin | 10 parts |
| (trade name: AMILAN CM800; available from Toray | |
| Industries, Inc.) | |
| Methoxymethylated nylon resin | 30 parts |
| (trade name: TORESIN EF30T; available from Nagase | |
| ChemteX Corporation) | |

The above solution was applied on the conductive layer by dip coating, followed by heat drying for 22 minutes in a hot-air dryer controlled at a temperature of 100° C., to form a subbing layer with a layer thickness of 0.45 μm.

Next, a liquid mixture containing the following three types of materials were subjected to dispersion for 10 hours by means of a sand mill using glass beads of 1 mm in diameter, and then 110 parts by mass of ethyl acetate was added to prepare a charge generation layer coating fluid.

| | (by mass) |
|---|---|
| Hydroxygallium phthalocyanine having strong peaks | 4 parts |
| at Bragg angles (2θ ± 0.2°) of 7.4° and 28.2° in | |
| CuKα characteristic X-ray diffraction | |
| Polyvinyl butyral | 2 parts |
| (trade name: S-LEC BX-1, available from Sekisui | |
| Chemical Co., Ltd.) | |
| Cyclohexanone | 90 parts |

The above coating fluid was applied on the subbing layer by dip coating, followed by heat drying for 22 minutes in a hot-air dryer controlled at a temperature of 80° C., to form a charge generation layer with a layer thickness of 0.17 μm.

Next, the following two kinds of materials were dissolved in a mixed solvent composed of 320 parts by mass of monochlorobenzene and 50 parts by mass of dimethoxymethane to prepare a charge transport layer coating solution.

| | (by mass) |
|---|---|
| Triarylamine compound represented by the following | 35 parts |
| structural formula (1) | |
| Bisphenol-Z polycarbonate resin | 50 parts |
| (trade name: IUPILON Z400; available from | |
| Mitsubishi Engineering-Plastics Corporation) | |

The above charge transport layer coating solution was applied on the charge generation layer by dip coating, followed by heat drying for 40 minutes in a hot-air dryer controlled at a temperature of 100° C., to form a charge transport layer with a layer thickness of 20 μm.

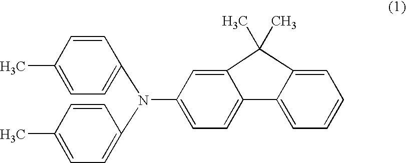

Next, 0.15 part of fluorine atom-containing resin (trade name: GF-300, available from Toagosei Chemical Industry Co., Ltd.) as a dispersant was dissolved in a mixed solvent of the following two types of solvents to prepare a liquid mixture.

| | (by mass) |
|---|---|
| 1,1,2,2,3,3,4-Heptafluorocyclopentane | 35 parts |
| (trade name: ZEOROLA H, available from Nippon Zeon | |
| Co., Ltd.) | |
| 1-Propanol | 35 parts |

To the above liquid mixture, 3 parts by mass of tetrafluoroethylene resin powder (trade name: LUBRON L-2, available from Daikin Industries, Ltd.) was added as a lubricant. Thereafter, the mixture obtained was treated three times under a pressure of 600 kgf/cm² by means of a high-pressure dispersion machine (trade name: MICROFLUIDIZER M-110EH, manufactured by Microfluidics Inc., USA) to effect uniform dispersion. The dispersion obtained was pressure-filtered with tetrafluoroethylene resin (PTFE) membrane filter of 10 μm in pore size to prepare a lubricant dispersion. To this lubricant dispersion, 27 parts by mass of a hole transporting compound represented by the following structural formula (2), having a polymerizable functional group, was added and this was pressure-filtrated with a 5 μm membrane filter made of PTFE, to prepare a protective layer coating fluid. A coating film was formed from this coating fluid on the charge transport layer by dip coating.

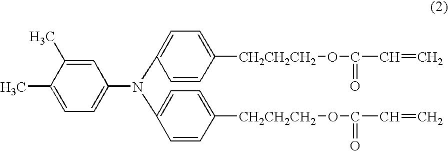

Thereafter, the aluminum cylinder having this coating film as the outermost surface layer was placed in an atmosphere of nitrogen, and the coating film was irradiated with electron rays under conditions of an accelerating voltage of 150 kV and a dose of 1.5 Mrad. Subsequently, heat treatment was carried out for 80 seconds under such conditions that the surface temperature of the outermost surface layer at the middle of this aluminum cylinder was 130° C. In this case, oxygen concentration in the atmosphere where the heat treatment was carried out was 10 ppm. Further, this aluminum cylinder having the coating film as the outermost surface layer was subjected to heat treatment for 20 minutes in a hot-air dryer controlled at a temperature of 100° C. in the atmosphere, to thereby form a surface layer with a layer thickness of 5 μm.

Formation of Depressed portions by Laser Light

On the surface layer obtained, depressed portions were formed by using a KrF excimer laser (wavelength λ: 248 nm; pulse width: 17 ns). The laser was provided with a mask made of quartz glass fitted to a quartz glass plate with a chromium oxide film which acted as an opaque area to the laser light (“a” in FIG. 5) and had a pattern in which circular transparent areas to the laser light of 30 μm in diameter (“b” in FIG. 5) were arranged at intervals of 10 μm. Irradiation was performed in an area of 2 mm square for each irradiation. As shown in FIG. 2, while the photosensitive member was moved and rotated so that the position to be irradiated was shifted in the axial direction and peripheral direction, the step of irradiating the surface layer at different regions was repeated. Thus, an electrophotographic photosensitive member was obtained the surface layer of which was processed to form depressed portions over the whole surface area.

Measurement of Depth of Depressed portions Formed

The surface profile of the electrophotographic photosensitive member obtained was observed under magnification with a laser microscope (VK-9500, manufactured by Keyence Corporation) to ascertain that, as shown in FIG. 6, depressed portions h and non-depressed portions g were arranged and circular depressed portions of 8.6 μm in diameter were formed at intervals of 2.9 μm. The depth of the depressed portions, which is an average value of depths of 10 depressed portions at their deepest bottoms, was 0.88 μm.

Evaluation of Electrophotographic Photosensitive Member in Practical Operation

Adjustment for practical operation: For this example, an electrophotographic copying machine (trade name: iRC6800, manufactured by CANON INC.) was so modified as to be fitted with a negative-charging organic electrophotographic photosensitive member. This copying machine was equipped with a cleaning blade made of polyurethane rubber.

The above electrophotographic photosensitive member was fitted in this copying machine to conduct tests, and characteristics such as potential and images were evaluated as shown below. In an environment of temperature 23° C./humidity 50% RH, conditions of potential were set so that the dark-area potential (Vd) and light-area potential (Vl) of the electrophotographic photosensitive member came to be Vd: −700 V and Vl: −200 V, respectively, and the initial potential of each electrophotographic photosensitive member to be evaluated was adjusted.

Evaluation of Cleaning Performance

To evaluate cleaning performance, two conditions were established, one of high pressure and one of low pressure to be used for the contact pressure of a cleaning blade. The linear pressure of the blade set at high pressure was 40 g/cm, and the linear pressure of the blade set at low pressure was 16 g/cm.

In an environment of temperature 23° C./humidity 50% RH, durability tests were conducted in which A4 full-color test images were printed on 5,000 sheets in a two-sheet intermittent mode to compare the results. After each durability test was completed, halftone test images were reproduced and any faults on images were observed.

In the case where the contact pressure of the blade was set high, the torque of rotation of the electrophotographic photosensitive member drum was monitored from electric-current values of the motor during the durability tests to evaluate whether or not the blade chattered or the blade turned up.

In the case where the contact pressure of the blade was set low, evaluation was made on whether or not any faulty cleaning occurred due to toner escape under the blade during the durability tests.

Measurement of Torque

Setting the blade at a linear pressure of 24 g/cm, the value of B/A was found from drive current value A at the initial stage and drive current value B after the 5,000-sheet durability test, of a motor for rotating the electrophotographic photosensitive member, and this value was regarded as the relative torque rise rate for comparison.

A durability test was further conducted in which A4 full-color test images were printed on 50,000 sheets in a two-sheet intermittent mode to evaluate cleaning performance in the same way.

Image Evaluation in High-Temperature and High-Humidity Environment

To evaluate images in a high-temperature and high-humidity environment, the above electrophotographic apparatus was placed in an environment of 30° C./80% RH, and a durability test was conducted in which setting the blade at a linear pressure of 24 g/cm, A4 lengthwise full-color test images were copied on 10,000 sheets in a two-sheet intermittent mode. Thereafter, halftone sample images were reproduced to evaluate whether or not any smeared images and any blank areas due to toner melt adhesion occurred.

Result Presentation

The results of evaluation are shown in Table 1. As shown in Table 1, the electrophotographic photosensitive member according to the present invention showed good and stable results under wide-range cleaning conditions. More specifically, it showed good results such that it was free of any toner escape and faulty cleaning in the case of low blade contact pressure and also free of any blade scraping, chattering or chipping and rise in drum torque in the case of high blade contact pressure. Any image defects such as smeared images and blank areas due to toner melt adhesion were also not seen even when a large number of sheets were printed over a long period of time in the high-temperature and high-humidity environment.

### Example 2

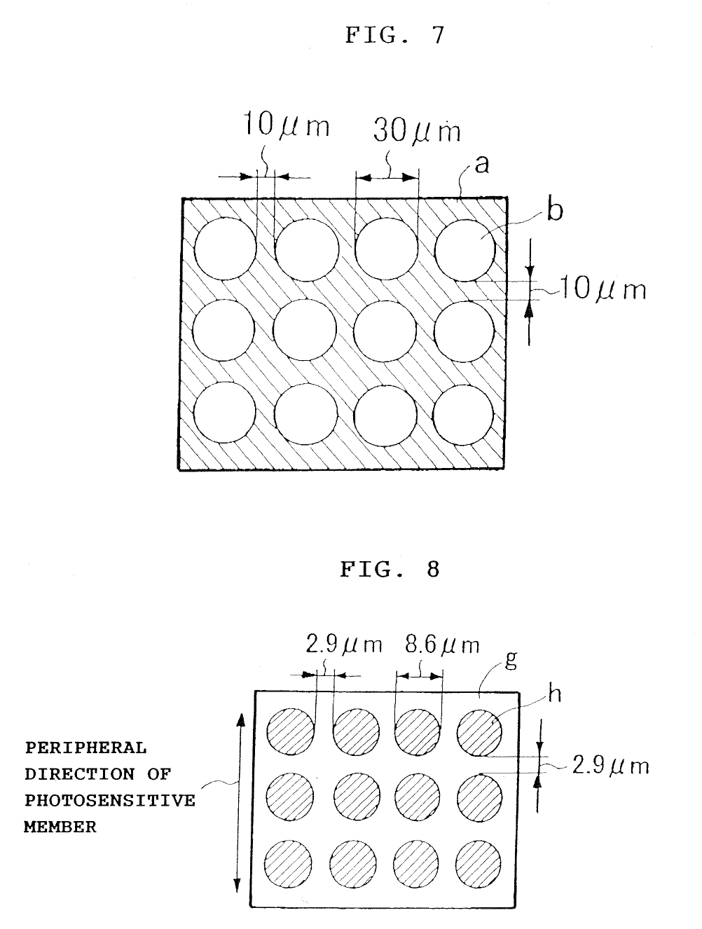

An electrophotographic photosensitive member was produced under entirely the same conditions as in Example 1 except that the pattern in the mask used in the excimer laser processing was changed to a pattern in which transparent areas to the laser light “b” were arranged in an opaque area to the laser light “a” as shown in FIG. 7.

The surface profile of the electrophotographic photosensitive member obtained was observed under magnification in the same way as in Example 1 to ascertain that depressed portions h as shown in FIG. 8 were formed. The depth of the depressed portions was 0.86 μm. Thereafter, this electrophotographic photosensitive member was fitted in the electrophotographic apparatus used in Example 1 to conduct tests and make an evaluation in the same way as those in Example 1. The results are shown in Table 1.

### Example 3

An electrophotographic photosensitive member was produced under entirely the same conditions as in Example 1 except that an excimer laser (wavelength λ: 351 nm; pulse width: 20 ns) using XeF as a laser medium was used. The depth of depressed portions formed was 0.75 μm. Thereafter, this electrophotographic photosensitive member was fitted in the electrophotographic apparatus used in Example 1 to conduct tests and make an evaluation in the same way as in Example 1. The results are shown in Table 1.

### Example 4

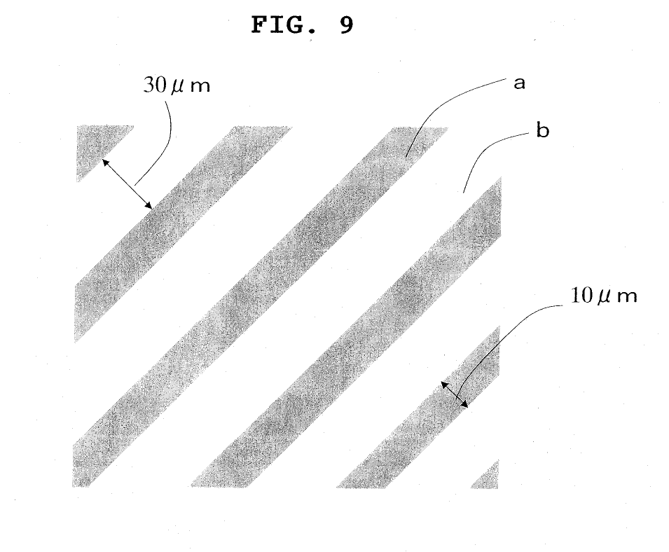

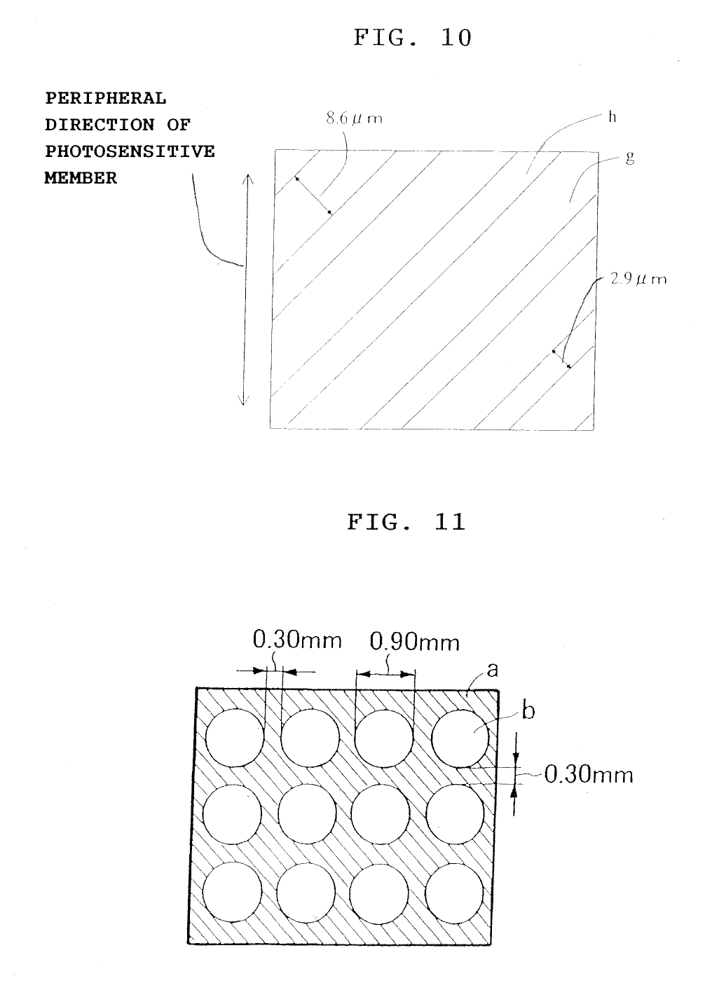

An electrophotographic photosensitive member was produced under entirely the same conditions as in Example 1 except that the pattern of the mask used in the excimer laser processing was changed to a pattern in which opaque areas to the laser light “a” and transparent areas to the laser light “b” were arranged as shown in FIG. 9. The surface profile of the electrophotographic photosensitive member obtained was observed under magnification in the same way as in Example 1 to ascertain that a large number of grooved (depressed portions) h were formed as shown in FIG. 10, in the oblique direction with respect to the peripheral direction of the photosensitive member. Here, the depth of depressed portions was 0.89 μm. Thereafter, this electrophotographic photosensitive member was fitted in the electrophotographic apparatus used in Example 1 to conduct tests and make evaluation in the same way as in Example 1. The results are shown in Table 1.

### Comparative Example 1

In the above Example 1, the procedure of Example 1 was repeated until the protective layer was formed. Thereafter, the outermost surface layer was not roughening-processed to obtain an electrophotographic photosensitive member. This electrophotographic photosensitive member was fitted to the electrophotographic apparatus used in Example 1 to conduct tests and make evaluation in the same way as those in Example 1. The results are shown in Table 1.

### Comparative Example 2

The procedure of Example 1 was repeated until the protective layer was formed, to produce an electrophotographic photosensitive member. Thereafter, the outermost surface layer was roughening-processed by using a rotary sander in stead of laser light. More specifically, the object to be processed was attached to the rotary sander. An abrasive-loaded brush (model name: TX #320C-W; manufactured by State Industry Co., Ltd.) was brought into contact with the electrophotographic photosensitive member surface at a brush indentation level of 0.45 mm. Then, the object to be processed (electrophotographic photosensitive member) was rotated at 50 rpm and the brush was rotated at 2,500 rpm in the counter direction for 100 seconds, thereby sanding the outermost surface layer in the peripheral direction.

The surface profile of this electrophotographic photosensitive member obtained was observed according to the method in Example 1. As the result, a large number of grooves having irregular width and depth were seen. The groove widths were scattered greatly in the range of from 3 μm to 60 μm and were 12 μm on the average. The groove intervals were in the range of from 0.3 μm to 70 μm and were 3 μm on the average. The groove depths were in the range of from 0.2 μm to 1.6 μm and were 0.95 μm on the average. Thereafter, this electrophotographic photosensitive member was fitted in the electrophotographic apparatus used in Example 1 to conduct tests and make evaluation in the same way as in Example 1. The results are shown in Table 1.

### Comparative Example 3

An electrophotographic photosensitive member was produced in the same manner as in Example 1 except that the outermost surface layer was roughening-processed using a TEA-CO₂ laser (wavelength: 10,600 nm; pulse width: 1,000 ns) in place of the excimer laser. In this case, a mask made of a metal was used, having a pattern in which transparent areas to the laser light “b” were arranged in an opaque area to the laser light “a” as shown in FIG. 11.

The surface layer was observed with a microscope to ascertain that depressed portions were not formed at the portions irradiated and that the charge transport layer was thermally fused and raised, so that the protective layer was pushed upward and cracked.

### Comparative Example 4

An electrophotographic photosensitive member was produced in the same manner as in Example 1 except that the outermost surface layer was roughening-processed using a YAG laser (wavelength: 1,060 nm; continuous oscillation) in place of the excimer laser. In this case, irradiation was carried out so that the portions irradiated were formed into circular spots of about 80 μm in diameter. The surface layer was observed with a microscope to ascertain that the portions irradiated were burned.

TABLE 1

| | Cleaning performance in | | | Cleaning performance in | | | |
|---|---|---|---|---|---|---|---|
| | 5,000-sheet durability | | | 50,000-sheet durability | | | |
| | test | | | test | | | |
| | Cleaning | Cleaning | | Cleaning | Cleaning | | |
| | performance | performance | | performance | performance | | Image evaluation |
| | in | in | | in | in | | in 10,000- |
| | setting | setting | | setting | setting | | sheet durability |
| | blade at | blade at | Torque | blade at | blade at | Torque | test at |
| | high | low | rise | high | low | rise | high temp. and |
| | pressure | pressure | rate | pressure | pressure | rate | high humidity |
| Ex. 1 | Good | Good | 1.2 | Good | Good | 1.4 | Good images |
| | cleaning | cleaning | | cleaning | cleaning | | |
| | performance | performance | | performance | performance | | |
| Ex. 2 | Good | Good | 1.5 | Slight | Good | 1.9 | Good images |
| | cleaning | cleaning | | blade | cleaning | | |
| | performance | performance | | scraping | performance | | |
| | | | | occurred | | | |
| | | | | on | | | |
| | | | | printing | | | |
| | | | | about | | | |
| | | | | 40,000 | | | |
| | | | | sheets | | | |
| Ex. 3 | Good | Good | 1.4 | Good | Good | 1.7 | Good images |
| | cleaning | cleaning | | cleaning | cleaning | | |
| | performance | performance | | performance | performance | | |
| Ex. 4 | Good | Good | 1.3 | Good | Good | 1.5 | Good images |
| | cleaning | cleaning | | cleaning | cleaning | | |
| | performance | performance | | performance | performance | | |
| Cp. 1 | Blade | Slight | 3.5 | Toner | Faulty | 6.2 | Blank areas |
| | scraping | blade | | escape | cleaning | | due to toner |
| | occurred | scraping | | due to | occurred | | melt adhesion |
| | | occurred | | blade | on | | occurred on |
| | | | | chattering | printing | | printing about |
| | | | | occurred | about | | 5,000 sheets |
| | | | | | 50,000 | | |
| | | | | | sheets | | |
| Cp. 2 | Good | Streaky | 2.4 | Faulty | Streaky | 4.8 | Streaky faulty |
| | cleaning | toner | | cleaning | faulty | | images |
| | performance | escape | | due to | images | | occurred on |
| | | under | | blade | occurred | | printing about |
| | | blade | | chipping | on | | 7,000 sheets |
| | | occurred | | occurred | printing | | |
| | | | | on | about | | |
| | | | | printing | 35,000 | | |
| | | | | about | sheets | | |
| | | | | 30,000 | | | |
| | | | | sheets | | | |

Ex.: Example
Cp.: Comparative Example

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A process for producing an electrophotographic photosensitive member having on a conductive support a surface layer containing at least a resin and having depressed portions on the surface thereof, the depressed portions being free from berms at their rims,
the process comprising the step of forming the depressed portions by irradiation with excimer laser light having a wavelength of 400 nm or less and having an output characteristic of a pulse width of 100 ns or less.

2. The process for producing an electrophotographic photosensitive member of claim 8, wherein the step of forming the depressed portions by irradiation with excimer laser light having a wavelength of 400 nm or less and having an output characteristic of a pulse width of 100 ns or less provides depressed portions being free from berms at their rims to reduce friction between the electrophotographic photosensitive member and a cleaning blade.
